(19) United States
(12) Patent Application Publication
(10) Pub. No.: US 2018/0201089 A1
(43) Pub. Date: Jul. 19, 2018

(54) SEAT AIR CONDITIONING DEVICE FOR VEHICLE

(71) Applicant: DENSO CORPORATION, Kariya-city, Aichi-pref. (JP)

(72) Inventors: Kouji FUJII, Kariya-city (JP); Hiroshi NAKAJIMA, Kariya-city (JP)

(21) Appl. No.: 15/744,321

(22) PCT Filed: Sep. 9, 2016
(86) PCT No.: PCT/JP2016/076614

§ 371 Date: Jan. 12, 2018

(30) Foreign Application Priority Data
Oct. 1, 2015 (JP) 2015-196072

(51) Int. Cl. B60H 1/00

(52) U.S. Cl. CPC B60H 1/00285; B60H 1/241; B60H 1/00564; B60H 1/00521

(57) ABSTRACT

A seat air conditioning device for a vehicle includes: an inflow space formation part that forms an inflow space; and a blower having a suction part in which an air suction port is defined to communicate with the inflow space, and a blower fan that draws air from the inflow space through the air suction port to send the air into a seat. The inflow space formation part has a space communication hole that causes the inflow space and a space of the vehicle interior to communicate with each other. An opening-and-closing door disposed in the inflow space formation space closes the space communication hole from an inner side of the inflow space formation part, and is moved for opening the space communication hole by an air pressure difference defined by subtracting an air pressure in the inflow space from an air pressure in the vehicle interior.

### CROSS REFERENCE TO RELATED APPLICATION

This application is based on Japanese Patent Application No. 2015-196072 filed on Oct. 1, 2015, the disclosure of which is incorporated herein by reference.

### TECHNICAL FIELD

The present disclosure relates to a seat air conditioning device for a vehicle, which sends air into a seat.

### BACKGROUND ART

As this kind of a seat air conditioning device for a vehicle, a seat air conditioning device for a vehicle, for example, described in Patent Literature 1 is known. The seat air conditioning device described in Patent Literature 1 has a blower arranged under a seat. The blower draws in conditioned-air flowing from an air-conditioning unit arranged at a front side of the vehicle interior through a duct, and sends the conditioned-air into a seat air passage formed in the seat.

Furthermore, the seat air conditioning device of Patent Literature 1 has a door in the duct. The door is rotated to connect an air suction port of the blower to an air passage communicated with the air-conditioning unit, or an air passage open to the vehicle interior. It is possible to change the air to be sent to the seat by the seat air conditioning device, at a desired timing, from the conditioned-air to air inside the vehicle interior.

By the changing from the conditioned-air to the air inside the vehicle interior, an occupant can be restricted from being too much cooled or heated, which is caused by, for example, continuously sending the conditioned-air such as cooled air or heated air blown off from the air-conditioning unit.

### PRIOR ART LITERATURES

### Patent Literature

Patent Literature 1: JP 2015-89682 A

### SUMMARY OF INVENTION

In the seat air conditioning device of Patent Literature 1, the door changes the air passage communicated with the air suction port of the blower, and the change operation of the door needs to be mechanically performed by an actuator. However, the blower and the door corresponding to a change mechanism of an air passage of the seat air conditioning device are generally installed under a seat, and the space under the seat is very narrow. The inventors found out that it is necessary to downsize and simplify the door as a change mechanism.

It is an object of the present disclosure to offer a seat air conditioning device for a vehicle, in which a door can be downsized and simplified, which selectively sends air inside the vehicle interior or conditioned-air to a seat.

To achieve the object, according to an aspect of the present disclosure, a seat air conditioning device for a vehicle causes air to flow into a seat, and includes:

an inflow space formation part that forms an inflow space into which air flows from a vehicle indoor air-conditioning unit conditioning air in a vehicle interior;

a blower having a suction part in which an air suction port is defined to communicate with the inflow space, and a blower fan that draws air from the inflow space through the air suction port to send the air into the seat; and

an opening-and-closing door.

The inflow space formation part has a space communication hole that causes the inflow space and a space of the vehicle interior to communicate with each other.

The opening-and-closing door is disposed in the inflow space formation space to open and close the space communication hole. The opening-and-closing door closes the space communication hole from an inner side of the inflow space formation part. The opening-and-closing door is moved in an opening direction for opening the space communication hole by an air pressure difference defined by subtracting an air pressure in the inflow space from an air pressure in the vehicle interior.

As mentioned above, the opening-and-closing door closes the space communication hole from the inner side of the inflow space formation part, when closing the space communication hole, and is moved for opening the space communication hole by the air pressure difference defined by subtracting the air pressure in the inflow space from the air pressure in the vehicle interior. Therefore, it is possible to open and close the opening-and-closing door to without using an actuator such as motor. For example, when the air inflow to the inflow space from the vehicle indoor air-conditioning unit stops, the blower will produce suction negative pressure in the inflow space, such that the opening-and-closing door is opened by the air pressure difference. Thus, it is possible to downsize and simplify the opening-and-closing door, as compared with a configuration in which an opening-and-closing door is operated, for example, by an actuator.

### BRIEF DESCRIPTION OF DRAWINGS

FIG. 1 is an exploded perspective view illustrating a seat air conditioning device for a vehicle according to a first embodiment and a vehicle seat to which air is supplied from the seat air conditioning device.

FIG. 2 is a sectional view taken along a line II-II of FIG. 1 in the first embodiment, and illustrating a hole closed state where an opening-and-closing door closes a space communication hole.

FIG. 3 is an enlarged view of an area III in FIG. 2.

FIG. 4 is a sectional view taken along a line II-II of FIG. 1 in the first embodiment, and illustrating a hole opened state where the opening-and-closing door opens the space communication hole.

FIG. 5 is an enlarged view of an area V in FIG. 4.

FIG. 6 is a sectional view taken along a line II-II of FIG. 1 in a second embodiment, and illustrating a hole closed state of an opening-and-closing door.

FIG. 7 is a sectional view taken along a line II-II of FIG. 1 in a third embodiment, and illustrating a hole closed state of an opening-and-closing door.

FIG. 8 is a sectional view taken along a line II-II of FIG. 1 in a fourth embodiment, and illustrating a hole closed state of an opening-and-closing door.

FIG. 9 is a cross-sectional view taken along a line IX-IX of FIG. 8 in the fourth embodiment.

### DESCRIPTION OF EMBODIMENTS

Hereinafter, embodiments will be described according to the drawings. Same or equivalent portions among respective embodiments below are labeled with same reference numerals in the drawings.

### First Embodiment

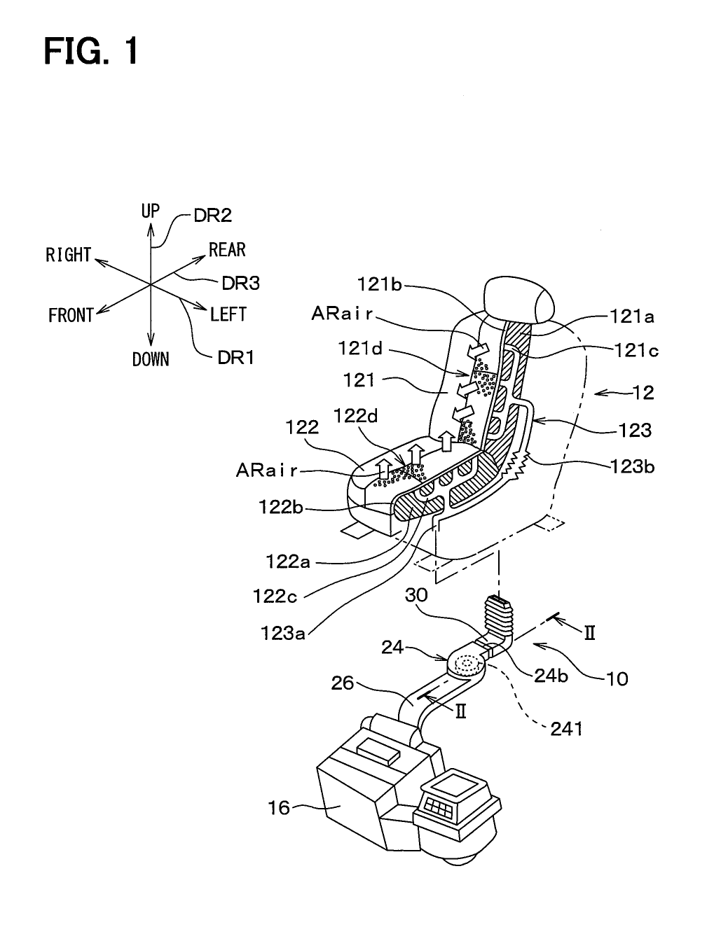

FIG. 1 is an exploded perspective view illustrating a seat air conditioning device 10 for a vehicle according to the present embodiment, and a vehicle seat 12 to which air is supplied from the seat air conditioning device 10. In FIG. 1, an arrow DR1 expresses a left-and-right direction DR1 of the vehicle, i.e., a vehicle width direction DR1, an arrow DR2 expresses an up-and-down direction DR2 of the vehicle, i.e., a vehicle up-and-down direction DR2, and an arrow DR3 expresses a front-and-rear direction DR3 of the vehicle, i.e., a vehicle front-and-rear direction DR3. In FIG. 1, the vehicle seat 12 is illustrated in the cross-section.

The seat air conditioning device 10 for a vehicle (hereafter referred to the seat air conditioning device 10) shown in FIG. 1 is a device which causes air to flow into the vehicle seat 12. In other words, the vehicle seat 12 is a target seat to which air is supplied from the seat air conditioning device 10. The vehicle seat 12 is a front seat such as a driver seat or a front passenger seat arranged at the front side of a non-illustrated rear seat.

The vehicle seat 12 has a seat back 121 corresponding to a backrest for an occupant seated on the vehicle seat 12, i.e., a seated person, and a seat cushion 122 to support a buttock and a thigh of the seated person as a seat bottom. The vehicle seat 12 is shaped symmetrical with respect to the vehicle width direction DR1.

The seat cushion 122 of the vehicle seat 12 has a seat pad 122a made of foamed urethane having elasticity, and a seat cover 122b disposed on the seat pad 122a to cover the surface of the seat pad 122a adjacent to the seated person.

The seat pad 122a has a seat ventilation passage 122c branched to send air from the seat air conditioning device 10 to the whole seat surface. The seat cover 122b is a perforated cover made of natural leather or artificial suede. Plural minute holes 122d are formed in the seat cover 122b, and pass through the seat cover 122b in the thickness direction.

Air emitted to the seat cover 122b from the seat ventilation passage 122c passes through the minute holes 122d of the seat cushion 122 and is blown out toward the seated person in an arrow direction ARair. The seat back 121 has a structure similar to the seat cushion 122. In FIG. 1, a seat pad of the seat back 121 is expressed with 121a, a seat cover of the seat back 121 is expressed with 121b, a seat ventilation passage of the seat back 121 is expressed with 121c, and minute holes of the seat back 121 are expressed with 121d.

The vehicle seat 12 has a distribution duct 123 that distributes the air from the seat air conditioning device 10 between the seat ventilation passage 121c of the seat back 121 and the seat ventilation passage 122c of the seat cushion 122. The distribution duct 123 has an air feed port 123a which is an entrance of air from the seat air conditioning device 10. The distribution duct 123 is connected to both of the seat ventilation passages 121c and 122c, and the air introduced into the air feed port 123a is led to each of the seat ventilation passages 121c and 122c.

The distribution duct 123 has a flexible part 123b which has flexibility to allow a reclining of the seat back 121. For example, the flexible part 123b has bellows form as the flexibility.

As shown in FIG. 1, the seat air conditioning device 10 is disposed under the vehicle seat 12 inside the vehicle interior. That is, the seat air conditioning device 10 is located between the vehicle seat 12 and the floor of the vehicle interior in the vehicle up-and-down direction DR2.

The seat air conditioning device 10 draws in conditioned-air from a vehicle indoor air-conditioning unit 16 which conditions air in the vehicle interior, and sends the air to the vehicle seat 12 as blast air. The seat air conditioning device 10 makes the blast air to blow off from the minute holes 121d, 122d of the seat back 121 and the seat cushion 122 to a seated person.

For example, the seat air conditioning device 10 can blow off air cooled in the vehicle indoor air-conditioning unit 16 from the vehicle seat 12 at a cooling time, and can blow off air heated by the vehicle indoor air-conditioning unit 16 from the vehicle seat 12 at a heating time.

The vehicle indoor air-conditioning unit 16 is a general air-conditioning unit including an evaporator and a heater core, and is arranged in the instrument panel ahead of the vehicle interior to condition air in the vehicle interior by circulating refrigerant heated or cooled by a heat exchanger outside the vehicle interior.

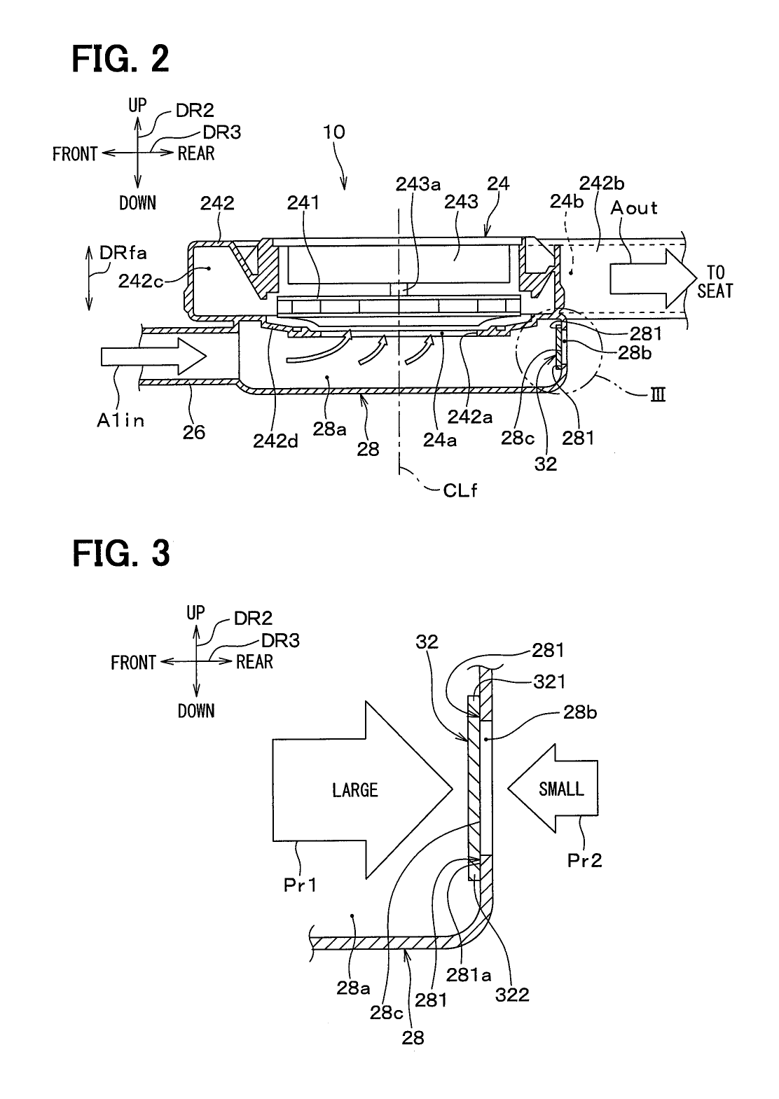

FIG. 2 is a sectional view taken along a line II-II of FIG. 1, and illustrates a hole closed state in which the opening-and-closing door 32 closes the space communication hole 28b. As shown in FIG. 2, the seat air conditioning device 10 includes a blower 24, an air introducing duct 26, an air entrance part 28, a connection duct 30, and the opening-and-closing door 32.

The blower 24 is an electric centrifugal type fan. The blower 24 draws in air from the air suction port 24a, and blows off the air from the air blow-off port 24b to the connection duct 30. Specifically, the blower 24 has a blower fan 241, a fan casing 242, and an electric motor 243. The air suction port 24a of the blower 24 is faced downward, and the air blow-off port 24b is faced rearward in the vehicle front-and-rear direction DR3. That is, the blower 24 blows off the air to the lateral side after drawing in from the bottom side.

The blower fan 241 is a sirocco fan, and has a large number of fan blades arranged about a fan axial center CLf which is one axial center extending in the vehicle up-and-down direction DR2. The blower fan 241 rotates about the fan axial center CLf. The blower fan 241 draws in air from the air suction side which is one side in the axial direction DRfa of the fan axial center CLf (namely, the fan axial center direction DRfa), and blows off the drawn air outward in the radial direction of the blower fan 241. Since the fan axial center CLf of the blower fan 241 is an axial center extending in the vehicle up-and-down direction DR2, the fan axial center direction DRfa is equal to the vehicle up-and-down direction DR2.

The suction part 242a of the fan casing 242 is formed at the air suction side of the blower fan 241, and the air suction port 24a is formed in the suction part 242a. That is, the blower fan 241 draws in air from the air suction port 24a in the fan axial center direction DRfa. In addition, the suction part 242a defines a peripheral portion of the air suction port 24a in the fan casing 242.

The air suction port 24a of the blower 24 seen from the fan axial center direction DRfa has a circle form centering at the fan axial center CLf. Moreover, the air suction side of the blower fan 241 is a lower side of the blower fan 241, and the air suction port 24a is formed at the lower side of the blower fan 241.

The fan casing 242 is made of, for example, plastic, and the blower fan 241 is housed in the fan casing 242. In addition to the suction part 242a, the fan casing 242 has the blow-off part 242b in which the air blow-off port 24b is formed. The air passage 242c is formed in the fan casing 242, and extends to surround the radially outer side of the blower fan 241. The air passage 242c is connected to the air blow-off port 24b. In the blower 24, the air flowing into the air passage 242c from the blower fan 241 gathers to the air blow-off port 24b, and flows out of the air blow-off port 24b into the connection duct 30 of FIG. 1 in an arrow direction Aout.

The electric motor 243 shown in FIG. 2 is arranged at the upper side of the blower fan 241, and is fixed to the fan casing 242. A rotation shaft 243a of the electric motor 243 is connected with the blower fan 241. The electric motor 243 rotates the blower fan 241 about the fan axial center CLf in response to a control signal output from a non-illustrated control device of the seat air conditioning device 10.

The air entrance part 28 is an inflow space formation part in which the inflow space 28a is formed where the air flowing from the vehicle indoor air-conditioning unit 16 flows in. In detail, the inflow space 28a is formed inside the air entrance part 28, and the air blow-off port of the vehicle indoor air-conditioning unit 16 is connected to the inflow space 28a through the air introducing duct 26. When conditioned-air flows from the vehicle indoor air-conditioning unit 16, the conditioned-air will flow into the inflow space 28a in an arrow direction A1 in through the air introducing duct 26.

The conditioned-air such as heated air or cooled air is blown off from the air blow-off port of the vehicle indoor air-conditioning unit 16 to which the air introducing duct 26 is connected. An electric blow-off port door which opens and closes the air blow-off port is prepared in the air blow-off port. The air entrance part 28 is made of, for example, plastic.

The inflow space 28a is formed at the lower side of the blower 24. The air suction port 24a of the blower 24 is open to the inflow space 28a, and is communicated with the inflow space 28a. Therefore, the blower fan 241 draws in air in the inflow space 28a through the air suction port 24a, and sends the air to the vehicle seat 12 through the air blow-off port 24b and the connection duct 30.

Since the fan casing 242 and the air entrance part 28 are integrally formed as one unit, a partition wall 242d between the inflow space 28a and a space housing the blower fan 241 in the fan casing 242 is shared by the fan casing 242 and the air entrance part 28. The suction part 242a is defined in the partition wall 242d. The fan casing 242 and the air entrance part 28 are fixed to, for example, the floor of the vehicle interior.

The air entrance part 28 has the space communication hole 28b which communicates the inflow space 28a with the space of the vehicle interior. That is, the space communication hole 28b is a through hole which connects the inflow space 28a and the space of the vehicle interior with each other. The opening-and-closing door 32 is arranged in the air entrance part 28, and opens and closes the space communication hole 28b. The opening-and-closing door 32 is made of, for example, urethane resin or rubber, which is rich in flexibility. The opening-and-closing door 32 is fabricated to have, for example, rectangular board form.

As shown in FIG. 3 which is an enlarged view of the area III in FIG. 2, in detail, the space communication hole 28b has an inflow space connection end 28c adjacent to the inflow space 28a. The air entrance part 28 has a connection end formation part 281 formed to surround the inflow space connection end 28c.

The opening-and-closing door 32 has one end part 321 at the upper side of the opening-and-closing door 32, and the other end part 322 at the lower side of the opening-and-closing door 32. The one end part 321 of the opening-and-closing door 32 is fixed to the air entrance part 28, and the other end part 322 is not fixed to the air entrance part 28. That is, only the one end part 321 is fixed to the air entrance part 28, of the peripheral portions of the opening-and-closing door 32. The opening-and-closing door 32 attached to the air entrance part 28 closes the space communication hole 28b by being pressed onto the connection end formation part 281.

In short, the opening-and-closing door 32 closes the space communication hole 28b from the inner side of the air entrance part 28. The other end part 322 of the opening-and-closing door 32 is pressed onto the connection end formation part 281 in a hole closed state where the opening-and-closing door 32 closes the space communication hole 28b. Specifically, the connection end formation part 281 has a contact surface 281a as an opposing surface opposing the opening-and-closing door 32 in the hole closed state of the opening-and-closing door 32. In the hole closed state, the opening-and-closing door 32 is pressed against the contact surface 281a. The contact surface 281a is formed so that a normal line of the contact surface 281a extends, for example, horizontally.

Operation of the opening-and-closing door 32 is explained. As shown in FIG. 2 and FIG. 3, since the opening-and-closing door 32 is arranged inside the air entrance part 28, the opening-and-closing door 32 is biased in an opening direction to open the space communication hole 28b by the air pressure of the vehicle interior. On the other hand, the opening-and-closing door 32 is biased in a closing direction to close the space communication hole 28b by the air pressure in the inflow space 28a.

Where the conditioned-air from the vehicle indoor air-conditioning unit 16 flows into the inflow space 28a, as shown in the arrow direction A1 in, the inside of the inflow space 28a of the air entrance part 28 is in a positive pressure state. The positive pressure state means a state where the air pressure in the space is higher than atmospheric pressure. The air pressure in the vehicle interior is equal to atmospheric pressure.

Therefore, in the state where the conditioned-air is made to flow in, as shown in arrows Pr1 and Pr2 of FIG. 3, due to the difference between the air pressure in the vehicle interior and the air pressure in the inflow space 28a, the biasing force for closing the opening-and-closing door 32 becomes larger than the biasing force for opening the opening-and-closing door 32, such that the opening-and-closing door 32 closes the space communication hole 28b. Therefore, of the air in the vehicle interior and the conditioned-air from the vehicle indoor air-conditioning unit 16, the blower fan 241 of the blower 24 draws in only the conditioned-air, and sends the conditioned-air to the vehicle seat 12.

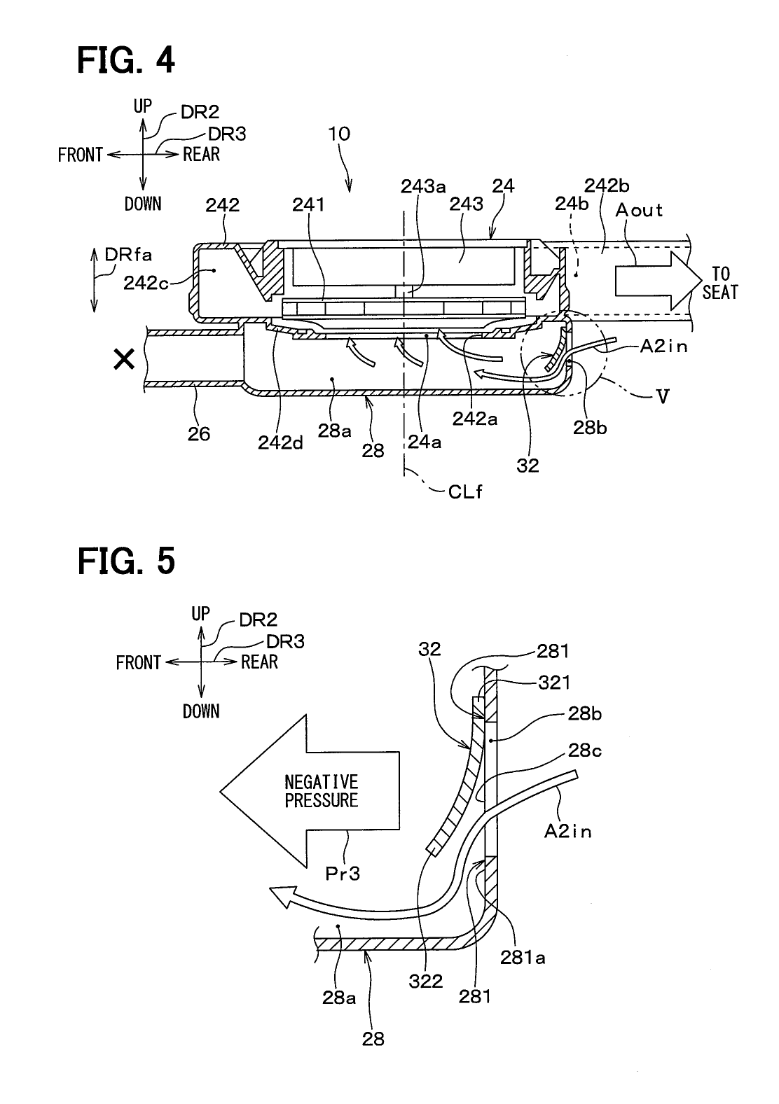

In contrast, as shown in FIG. 4 and FIG. 5, when the air-sending from the vehicle indoor air-conditioning unit 16 to the inflow space 28a stops, since the blower fan 241 continues the operation drawing in the air in the inflow space 28a, the inside of the inflow space 28a is in a negative pressure state. The negative pressure state means a state where air pressure in the space is lower than atmospheric pressure.

Therefore, in the state where the air-sending from the vehicle indoor air-conditioning unit 16 has stopped, as shown in the arrow Pr3 of FIG. 5, the biasing force for opening the opening-and-closing door 32 becomes larger than the biasing force for closing the opening-and-closing door 32. That is, the opening-and-closing door 32 is moved for opening by the air pressure difference defined by subtracting the air pressure in the inflow space 28a from the air pressure in the vehicle interior. In detail, the opening-and-closing door 32 deforms and is curved between the one end part 321 and the other end part 322 of the opening-and-closing door 32, and the other end part 322 separates from the connection end formation part 281, such that the space communication hole 28b is opened. Furthermore, the opening-and-closing door 32 is biased more strongly for opening, as the air pressure difference defined by subtracting the air pressure in the inflow space 28a from the air pressure in the vehicle interior is larger.

When the space communication hole 28b is opened, the blower fan 241 of the blower 24 draws in air in the vehicle interior through the space communication hole 28b as shown in the arrow A2in, and sends the air to the vehicle seat 12.

In addition, the opening-and-closing door 32 of this embodiment is configured to open the space communication hole 28b, for example, when the air pressure difference defined by subtracting the air pressure in the inflow space 28a from the air pressure of the vehicle interior exceeds a predetermined threshold value which is a positive value, in consideration of the self-weight and the flexural rigidity of the opening-and-closing door 32.

Returning to FIG. 1, the connection duct 30 is a component made of plastic, and is fabricated by injection molding or vacuum forming. Further, the connection duct 30 is a piping component which leads the air from the air blow-off port 24b of the blower 24 to the air feed port 123a of the distribution duct 123. That is, one end of the connection duct 30 is connected to the air blow-off port 24b of the blower 24, and the other end of the connection duct 30 is connected to the air feed port 123a of the distribution duct 123. Therefore, the air blow-off port 24b of the blower 24 is connected to the seat ventilation passages 121c and 122c through the connection duct 30 and the distribution duct 123. Due to such connection, the blower 24 can send the air from the inflow space 28a of the air entrance part 28 into the seat ventilation passages 121c, 122c formed in the vehicle seat 12.

The connection duct 30 has L-shape in order to communicate the air blow-off port 24b of the blower 24, which extends horizontally, to the air feed port 123a, which extends downward. The connection duct 30 has bellows portion fabricated to produce flexibility, such that the seat back 121, the seat cushion 122, and the distribution duct 123 are allowed to move in the vehicle front-and-rear direction DR3.

As mentioned above, according to this embodiment, the opening-and-closing door 32 closes the space communication hole 28b from the inner side of the air entrance part 28. The opening-and-closing door 32 is biased for opening the space communication hole 28b by the air pressure of the vehicle interior, while the opening-and-closing door 32 is biased for closing the space communication hole 28b by the air pressure in the inflow space 28a. That is, the opening-and-closing door 32 is moved in the opening direction by the air pressure difference defined by subtracting the air pressure in the inflow space 28a from the air pressure of the vehicle interior. Therefore, it is possible to open and close the opening-and-closing door 32 without using actuator such as motor.

For example, when the air inflow to the inflow space 28a from the vehicle indoor air-conditioning unit 16 stops, since the blower 24 produces a suction negative pressure in the inflow space 28a, the opening-and-closing door 32 is moved in the opening direction by the air pressure difference. Therefore, as compared with a configuration where the opening-and-closing door 32 is operated by an actuator, it is possible to downsize and simplify the opening-and-closing door 32.

Moreover, according to this embodiment, the opening-and-closing door 32 is biased more strongly in the opening direction, as the air pressure difference defined by subtracting the air pressure in the inflow space 28a from the air pressure of the vehicle interior is increased. Therefore, as the amount of air sent by the blower 24 is increased in the state where the air-sending from the vehicle indoor air-conditioning unit 16 has stopped, the opening degree of the space communication hole 28b is increased, such that air in the vehicle interior can be easily take in.

Moreover, according to this embodiment, as shown in FIG. 3, the opening-and-closing door 32 closes the space communication hole 28b by being pressed onto the connection end formation part 281. Therefore, it is possible to simplify the structure where the opening-and-closing door 32 closes the space communication hole 28b.

Moreover, according to this embodiment, as shown in FIG. 5, the opening-and-closing door 32 deforms between the one end part 321 and the other end part 322 of the opening-and-closing door 32, and the other end part 322 separates from the connection end formation part 281 so as to open the space communication hole 28b. Therefore, it is possible to simplify the structure enabling the opening-and-closing operation of the opening-and-closing door 32 using the deform of the opening-and-closing door 32.

### Second Embodiment

A second embodiment is described. This embodiment is described mainly at a different point from the first embodiment. A portion the same as or equivalent to the previous embodiment is omitted or simplified. This is applied to the third and the subsequent embodiments.

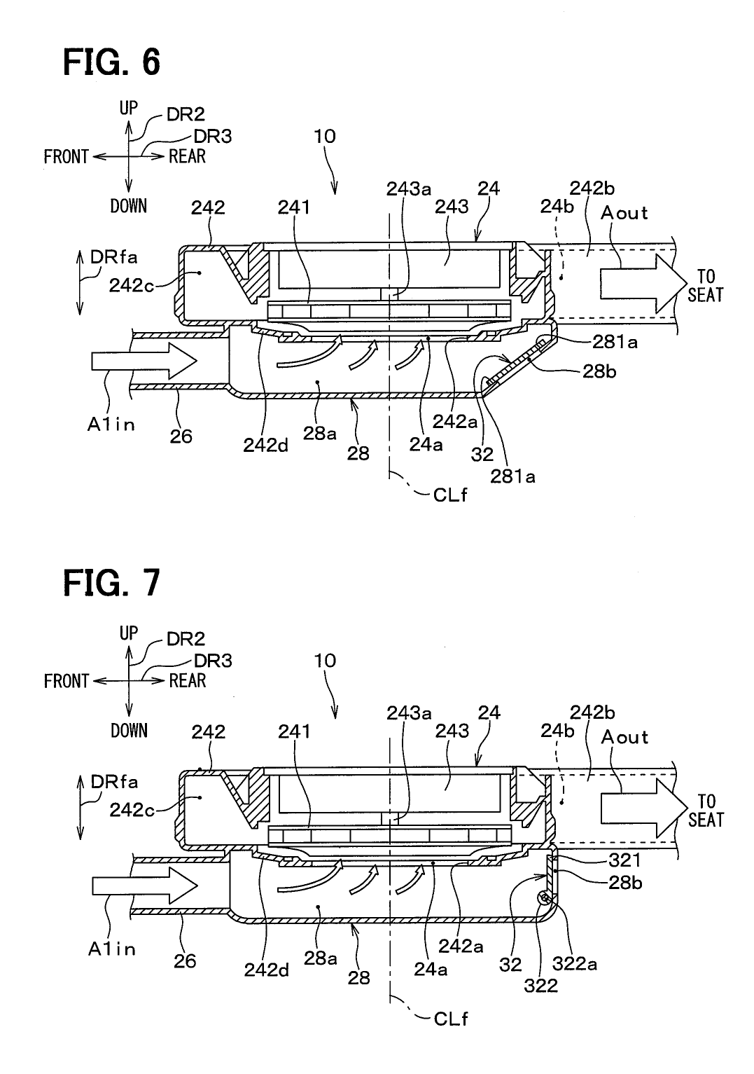

FIG. 6 is a view corresponding to FIG. 2 of the first embodiment. As shown in the FIG. 6, in this embodiment, the orientation of the opening-and-closing door 32 attached to the air entrance part 28 and the peripheral form of the air entrance part 28 adjacent to the opening-and-closing door 32 differ from those in the first embodiment.

Specifically, the contact surface 281a of the air entrance part 28 of this embodiment, onto which the opening-and-closing door 32 is pressed, is sloped obliquely to face upward. Therefore, the opening-and-closing door 32 closes the space communication hole 28b, in the sloped state along the contact surface 281a. That is, in the hole closed state of the opening-and-closing door 32, the other end part 322 of the opening-and-closing door 32 shown in FIG. 3 is located at inner side of the one end part 321 in the radial direction of the fan axial center CLf, and the opening-and-closing door 32 closes the space communication hole 28b with the orientation.

Thus, according to this embodiment, as shown in FIG. 6, the opening-and-closing door 32 closes the space communication hole 28b with the sloped state along the contact surface 281a of the air entrance part 28. Therefore, the hole closed state of the opening-and-closing door 32 can be easily maintained using the self-weight of the opening-and-closing door 32. That is, it is possible to give robustness over the pressure change in the inflow space 28a, relative to an action of the opening-and-closing door 32 opening and closing the space communication hole 28b. As the result, it is possible to avoid non-intentional air-sending to the vehicle seat 12 from the vehicle interior. Further, it is possible to control the opening-and-closing action of the opening-and-closing door 32 in accordance with the difference between the air pressure in the vehicle interior and the air pressure in the inflow space 28a, by fixing the inclination angle of the opening-and-closing door 32 and the inclination angle of the contact surface 281a to a desired value, in the hole closed state of the opening-and-closing door 32.

Moreover, in this embodiment, the effect of the first embodiment can be similarly acquired based on the common configuration.

### Third Embodiment

A third embodiment is described. This embodiment is mainly explained at a different point from the first embodiment.

FIG. 7 is a view corresponding to FIG. 2 of the first embodiment. As shown in FIG. 7, in this embodiment, the structure of the opening-and-closing door 32 differs from that in the first embodiment.

Specifically, in the hole closed state where the opening-and-closing door 32 closes the space communication hole 28b, the other end part 322 of the opening-and-closing door 32 is located at the lower side of the one end part 321. The other end part 322 is arranged at the same position as the one end part 321 in the radial direction of the fan axial center CLf. In short, in the hole closed state, the other end part 322 of the opening-and-closing door 32 is located just under the one end part 321. This point of the present embodiment is the same as the first embodiment.

However, unlike the first embodiment, the opening-and-closing door 32 of the present embodiment is made partially heavy at the other end part 322. In other words, of the opening-and-closing door 32, the other end part 322 is made heavy per the same volume, as compared with the other parts.

For example, the other end part 322 of the opening-and-closing door 32 is configured to include a weight 322a with large specific gravity as compared with rubber which is a main material of the opening-and-closing door 32. Therefore, the other end part 322 of the opening-and-closing door 32 is heavier than the one end part 321.

Thus, according to this embodiment, as shown in FIG. 7, the opening-and-closing door 32 is partially made heavy in the other end part 322. Therefore, it is possible to give robustness over the pressure change in the inflow space 28a relative to an action of the opening-and-closing door 32 opening and closing the space communication hole 28b. Further, it is possible to control the opening-and-closing action of the opening-and-closing door 32 in accordance with the difference between the air pressure of the vehicle interior and the air pressure in the inflow space 28a by setting the mass of the weight 322a into a desired value.

Moreover, in this embodiment, the effect of the first embodiment can be acquired due to the common configuration.

Although this embodiment is a modification based on the first embodiment, it is also possible to combine this embodiment with the second embodiment.

### Fourth Embodiment

A fourth embodiment is described. This embodiment is mainly explained at a different point from the first embodiment.

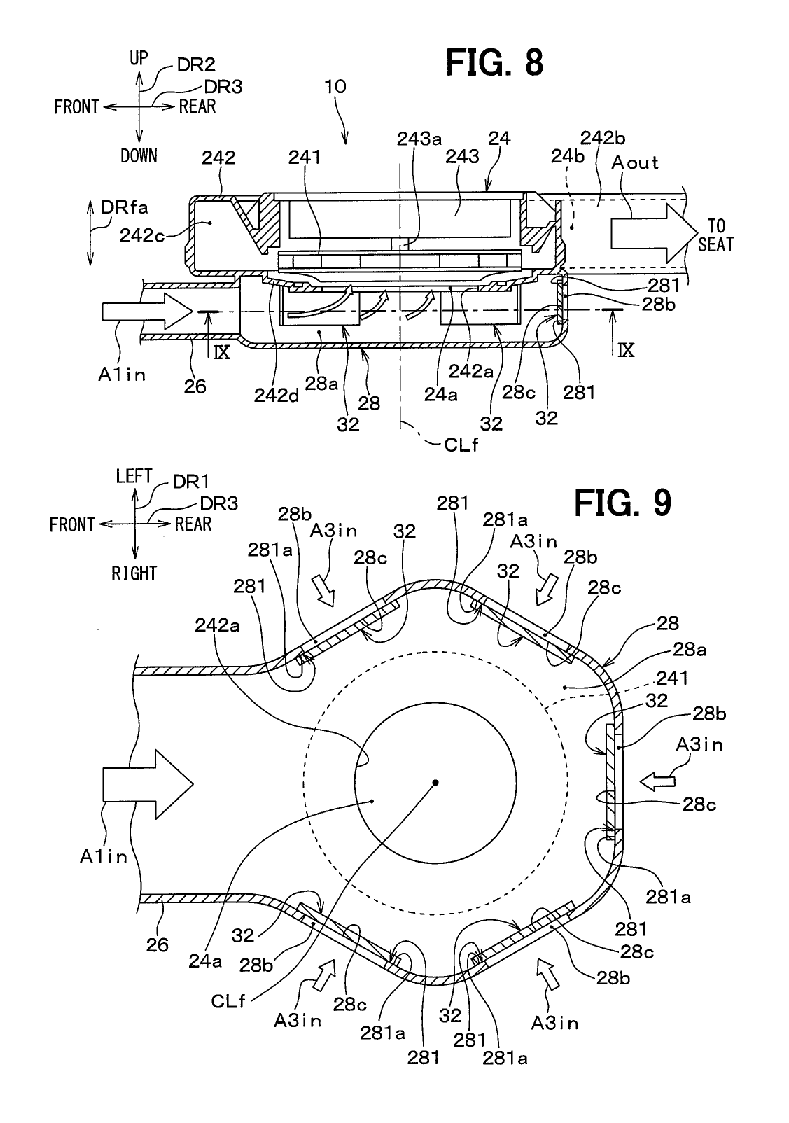

FIG. 8 is a view corresponding to FIG. 2 of the first embodiment. FIG. 9 is a cross-sectional view taken along a line IX-IX of FIG. 8. As shown in FIG. 8 and FIG. 9, in this embodiment, plural opening-and-closing doors 32 and plural space communication holes 28b are formed, and this point differs from the first embodiment.

Specifically, in this embodiment, five opening-and-closing doors 32 are formed, and five space communication holes 28b are formed in the air entrance part 28. The opening-and-closing doors 32 are arranged in the circumferential direction of the fan axial center CLf. Similarly, the space communication holes 28b are arranged in the circumferential direction of the fan axial center CLf.

All of the opening-and-closing doors 32 and the space communication holes 28b are located at an outer side of the air suction port 24a of the blower 24 in the radial direction of the fan axial center CLf. When seen from the fan axial center direction DRfa, the inflow space connection ends 28c of the space communication holes 28b are faced to the inner side in the radial direction of the fan axial center CLf.

Thus, as shown in FIG. 9, according to this embodiment, when seen from the fan axial center direction DRfa, the inflow space connection end 28c of the space communication hole 28b is faced to the inner side in the radial direction of the fan axial center CLf. Therefore, when the space communication hole 28b is opened, as shown in the arrow direction A3in, it is possible to smoothly direct air from the vehicle interior into the air suction port 24a of the blower 24 through the space communication hole 28b and the inflow space 28a.

Moreover, in this embodiment, the effect of the first embodiment can be acquired based on the common configuration.

Although this embodiment is a modification based on the first embodiment, it is also possible to combine this embodiment with the second embodiment or the third embodiment.

### Other Embodiment

(1) In each of the embodiments, although the opening-and-closing door 32 opens the space communication hole 28b by deforming to be curved, the opening-and-closing door 32 may be a door not deforming. For example, the opening-and-closing door 32 may be a rotary door in which the one end part 321 is supported by the air entrance part 28 to be rotatable. When the opening-and-closing door 32 is such a rotary door, the opening-and-closing door 32 is moved in the opening direction by the air pressure difference defined by subtracting the air pressure in the inflow space 28a from the air pressure of the vehicle interior.

(2) In the third embodiment, in the hole closed state of the opening-and-closing door 32, although the other end part 322 of the opening-and-closing door 32 is located the same position as the one end part 321 in the radial direction of the fan axial center CLf, it is not restricted to such arrangement. For example, in the hole closed state, as shown in FIG. 6, the opening-and-closing door 32 may be in a sloped state, and the other end part 322 may be located at the inner side of the one end part 321 in the radial direction of the fan axial center CLf.

(3) In each of the embodiments, although the opening-and-closing door 32 is fabricated to have, for example, rectangular plane form, there is no limitation in the form of the opening-and-closing door 32.

(4) In each of the embodiments, the seat air conditioning device 10 blows out air cooled in the vehicle indoor air-conditioning unit 16 at a cooling time from the vehicle seat 12, and blows out air heated by the vehicle indoor air-conditioning unit 16 from the vehicle seat 12 at a heating time, as an example. It is not necessary for the seat air conditioning device 10 to have the function to blow off both of the cooled air and the heated air. The seat air conditioning device 10 may blow off only one of the cooled air and the heated air from the vehicle seat 12.

(5) In each of the embodiments, although the blower 24 is a centrifugal type fan, there is no limitation in the type. For example, the blower may be an axial current type fan.

(6) In the fourth embodiment, the plural opening-and-closing doors 32 and the plural space communication holes 28b are formed. However, the number of the opening-and-closing doors 32 may be only one, and the number of the plural space communication holes 28b may be only one.

It should be appreciated that the present disclosure is not limited to the embodiments described above and can be modified appropriately within the scope of the appended claims. The embodiments above are not irrelevant to one another and can be combined appropriately unless a combination is obviously impossible. In the respective embodiments above, it goes without saying that elements forming the embodiments are not necessarily essential unless specified as being essential or deemed as being apparently essential in principle. In a case where a reference is made to the components of the respective embodiments as to numerical values, such as the number, values, amounts, and ranges, the components are not limited to the numerical values unless specified as being essential or deemed as being apparently essential in principle. Also, in a case where a reference is made to the components of the respective embodiments above as to shapes and positional relations, the components are not limited to the shapes and the positional relations unless explicitly specified or limited to particular shapes and positional relations in principle.

What is claimed is:

1. A seat air conditioning device for a vehicle, which causes air to flow into a seat, comprising:
an inflow space formation part that forms an inflow space into which air flows from a vehicle indoor air-conditioning unit conditioning air in a vehicle interior;
a blower having a suction part in which an air suction port is defined to communicate with the inflow space, and a blower fan that draws air from the inflow space through the air suction port to send the air into the seat; and
an opening-and-closing door, wherein
the inflow space formation part has a space communication hole that causes the inflow space and a space of the vehicle interior to communicate with each other, and
the opening-and-closing door is disposed in the inflow space formation space to open and close the space communication hole, the opening-and-closing door closing the space communication hole from an inner side of the inflow space formation part, the opening-and-closing door being moved in an opening direction for opening the space communication hole by an air pressure difference defined by subtracting an air pressure in the inflow space from an air pressure in the vehicle interior.

2. The seat air conditioning device according to claim 1, wherein
the opening-and-closing door is biased in the opening direction more strongly, as the air pressure difference is increased.

3. The seat air conditioning device according to claim 1, wherein
the space communication hole has an inflow space connection end adjacent to the inflow space,
the inflow space formation part has a connection end formation part formed by surrounding the inflow space connection end, and
the opening-and-closing door closes the space communication hole by being pressed onto the connection end formation part.

4. The seat air conditioning device according to claim 3, wherein
the opening-and-closing door has flexibility,
the opening-and-closing door has one end part fixed to the inflow space formation part, and the other end part pressed onto the connection end formation part in the state where the space communication hole is closed, and
the opening-and-closing door is deformed between the one end part and the other end part, and the other end part separates from the connection end formation part to open the space communication hole.

5. The seat air conditioning device according to claim 4, wherein
the blower fan rotates about a fan axial center extending up and down, and draws in air from the air suction port in an axial direction of the fan axial center,
the other end part of the opening-and-closing door is located at a lower side of the one end part, and is located the same position as the one end part, or at an inner side of the one end part in a radial direction of the fan axial center in the state where the opening-and-closing door closes the space communication hole, and
the opening-and-closing door is partially made heavy at the other end part.

6. The seat air conditioning device according to claim 3, wherein
the blower fan rotates about a fan axial center, and draws in air from the air suction port in an axial direction of the fan axial center,
the opening-and-closing door is arranged at an outer side of the air suction port in a radial direction of the fan axial center, and
the inflow space connection end of the space communication hole is faced to an inner side in the radial direction when being seen from the axial direction.

7. The seat air conditioning device according to claim 6, wherein
the space communication hole is one of a plurality of space communication holes formed in the inflow space formation part,
the opening-and-closing door is one of a plurality of opening-and-closing doors, and
the plurality of opening-and-closing doors are arranged in a circumferential direction of the fan axial center, and the plurality of space communication holes are arranged in the circumferential direction.

8. The seat air conditioning device according to claim 3, wherein
the connection end formation part has a contact surface onto which the opening-and-closing door is pressed,
the contact surface is sloped to face obliquely upward, and
the opening-and-closing door closes the space communication hole in a sloped state along the contact surface.
